(19) United States
(12) Patent Application Publication
(10) Pub. No.: US 2013/0345976 A1
(43) Pub. Date: Dec. 26, 2013

(54) METHOD AND APPARATUS FOR PLANNING ROUTE OF ELECTRIC VEHICLE

(71) Applicant: NEC (CHINA) CO., LTD., Beijing (CN)

(72) Inventors: Man Li, Beijing (CN); Weisong Hu, Beijing (CN); Xiaowei Liu, Beijing (CN)

(73) Assignee: NEC (China) Co., Ltd., Beijing (CN)

(21) Appl. No.: 13/870,541

(22) Filed: Apr. 25, 2013

(30) Foreign Application Priority Data
Jun. 21, 2012 (CN) CN201210212656.0

(51) Int. Cl. G01C 21/34

(52) U.S. Cl. CPC G01C 21/3476; G01C 21/3469
USPC 701/533

(57) ABSTRACT

A method and apparatus are provided for planning a route of an electric vehicle so as to give a globally optimal route over which the electric vehicle travels and to enable the electric vehicle to prepare for a next trip upon arrival at a destination. The method includes: determining location information of respective candidate charging stations and respective sequences of candidate charging stations according to acquired location information of an origin and location information of a destination as predetermined, charging facility information of the destination and an initial amount of power; calculating for each sequence of candidate charging stations a route parameter of arrival at the destination from the origin sequentially through the candidate charging stations included in the sequence of candidate charging stations; and selecting an optimal route according to route parameters of the respective sequences of candidate charging stations and a predetermined route selection criterion.

### FIELD

The present invention relates to a route planning method and particularly to a method and apparatus for planning a route of an electric vehicle.

### BACKGROUND

Environments and energy sources are hot issues currently earning global attention, and in view of alleviating environmental and energy source stresses, electric vehicles have gained popular attention throughout the world. The electric vehicles have been rapidly developed due to their advantages of low noise, no pollution, energy saving, etc., as compared with traditional vehicles.

Batteries are important components of the electric vehicles and also a predominating factor limiting the maximum mileage (i.e., a voyage mileage) over which the electric vehicles can travel so that the electric vehicles frequently have to locate a charging station for charging the batteries in the course of traveling. Thus it is of great importance to plan a route of an electric vehicle for traveling, but planning of a route of a traditional vehicle without taking into account a voyage mileage of an initial amount of power of the electric vehicle, a distribution of charging stations and other factors can not be applicable to the electric vehicle.

It has been an important issue under study regarding how to plan a route for an electric vehicle so that the electric vehicle can be charged in a timely manner to ensure smooth arrival of the electric vehicle at a destination and an optimal route can be provided in order for an optimal traveling effect.

In view of this, the invention provides a method and apparatus for planning a route of an electric vehicle.

### SUMMARY

The invention provides a method and apparatus for planning a route of an electric vehicle so as to give a globally optimal route over which the electric vehicle travels and to enable the electric vehicle to prepare for a next trip upon arrival at a destination.

Particular technical solutions according to embodiments of the invention are as follows:

A method of planning a route of an electric vehicle includes:

determining location information of respective candidate charging stations and respective sequences of candidate charging stations according to acquired location information of an origin and location information of a destination as predetermined, charging facility information of the destination and an initial amount of power;

calculating for each sequence of candidate charging stations a route parameter of arrival at the destination from the origin sequentially through the candidate charging stations included in the sequence of candidate charging stations; and

selecting an optimal route according to route parameters of the respective sequences of candidate charging stations and a predetermined route selection criterion.

An apparatus for planning a route of an electric vehicle includes:

a determining module configured to determine location information of respective candidate charging stations and respective sequences of candidate charging stations according to acquired location information of an origin and location information of a destination as predetermined, charging facility information of the destination and an initial amount of power;

a processing module configured to calculate for each sequence of candidate charging stations a route parameter of arrival at the destination from the origin sequentially through the candidate charging stations included in the sequence of candidate charging stations; and

a selecting module configured to select an optimal route according to route parameters of the respective sequences of candidate charging stations and a predetermined route selection criterion.

Based upon the foregoing technical solutions, in the embodiments of the invention, after location information of an origin and location information of a destination as predetermined and charging facility information of the destination is acquired, location information of respective candidate charging stations on the way and respective sequences of candidate charging stations are determined in combination with an initial amount of power, and with a route determined for each sequence of candidate charging stations, a route parameter of arrival at the destination from the origin through the respective candidate charging stations included in the sequence of candidate charging stations is calculated, and route parameters are compared and then an optimal route is selected therefrom as a globally optimal traveling route. The optimal route is selected also taking into account a charging facility condition of the destination, and a next trip of the electric vehicle upon arrival at the destination is guaranteed so that the electric vehicle can arrive at the destination smoothly and prepare for the next trip.

### BRIEF DESCRIPTION OF THE DRAWINGS

FIG. 1 is a general frame diagram of planning a route of an electric vehicle in an embodiment of the invention;

FIG. 2 is a flow chart of a method of planning a route of an electric vehicle in an embodiment of the invention;

FIG. 3 is a first schematic diagram of planning a route of an electric vehicle in an embodiment of the invention;

FIG. 4 is a second schematic diagram of planning a route of an electric vehicle in an embodiment of the invention;

FIG. 5 is a third schematic diagram of planning a route of an electric vehicle in an embodiment of the invention; and

FIG. 6 is a schematic structural diagram of an apparatus for planning a route of an electric vehicle in an embodiment of the invention.

### DETAILED DESCRIPTION OF THE EMBODIMENTS

Embodiments of the invention provide a method and apparatus for planning a route of an electric vehicle so as to give a globally optimal route over which the electric vehicle travels and to enable the electric vehicle to prepare for a next trip upon arrival at a destination.

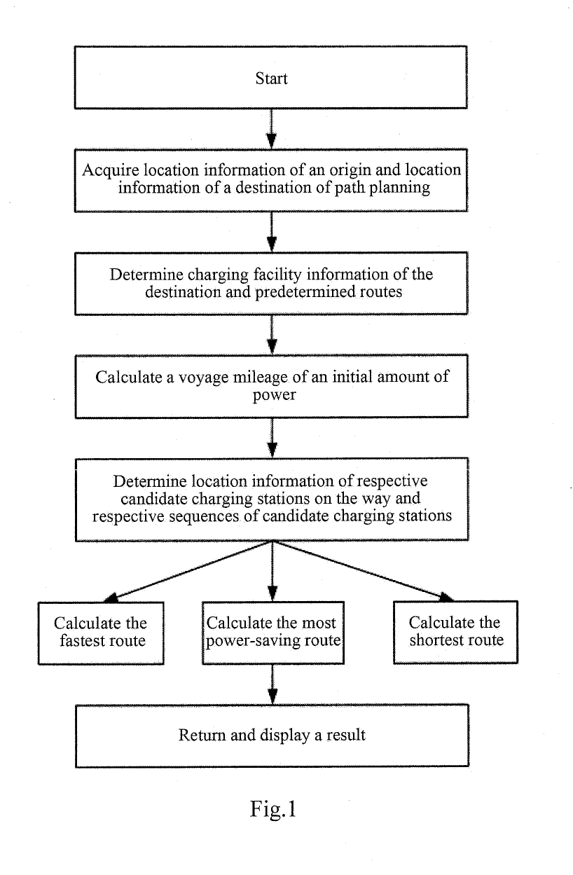

A general idea of planning a route of an electric vehicle according to the invention is as illustrated in FIG. 1 where after route planning is initiated, firstly location information of an origin and location information of a destination for route planning is acquired; then map information is searched according to the acquired location information of the destination and charging facility information of the destination is determined, and different predetermined routes are determined according to whether there is a charging facility at the destination; a voyage mileage of an initial amount of power of the electric vehicle at the origin (the maximum mileage over which it can travel with the initial amount of power) is calculated; whether the destination can be reached directly over the predetermined routes is determined according to the voyage mileage of the initial amount of power, and if not so, then location information of respective candidate charging stations on the way and respective sequences of candidate charging stations are determined; and route parameters are calculated for respective routes corresponding to respective sequences of candidate charging stations, the fastest, the most power-saving or the shortest route is selected as an optimal route, and a result is returned and displayed, thus ending the route planning process.

Preferred embodiments of the invention will be detailed below with reference to the drawings.

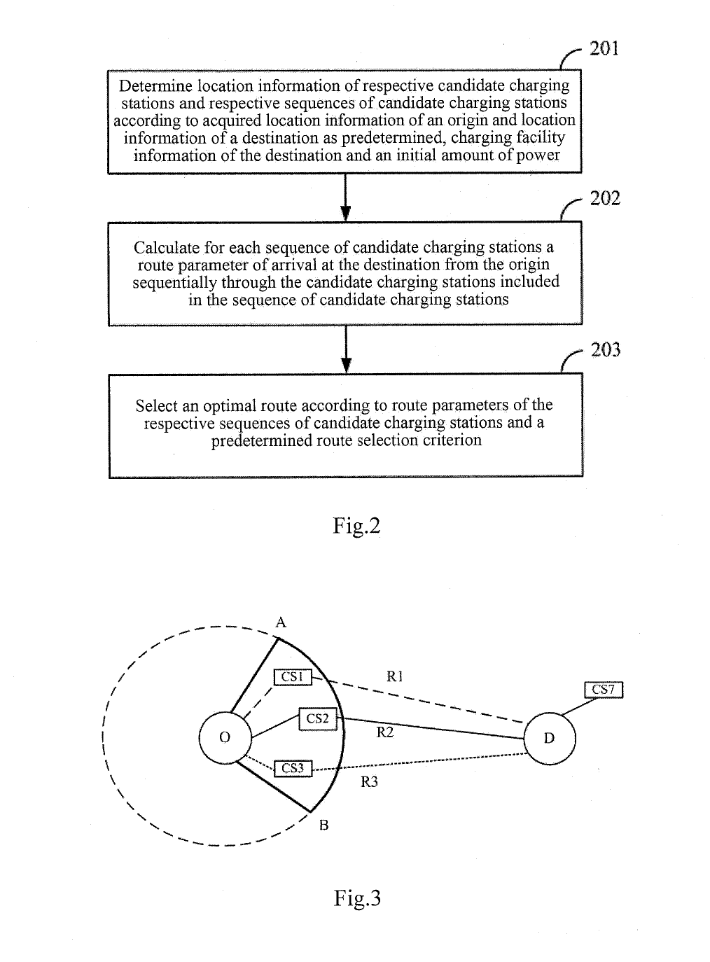

As illustrated in FIG. 2, a detailed flow of a method of planning a route of an electric vehicle according to an embodiment of the invention is as follows:

The step 201 is to determine location information of respective candidate charging stations and respective sequences of candidate charging stations according to acquired location information of an origin and location information of a destination as predetermined, charging facility information of the destination and an initial amount of power.

In a practical application, the predetermined location information of the origin and location information of the destination can be input into a device in which the route planning method according to the embodiment of the invention is applied after being specified by a user.

Particularly the charging facility information of the destination indicates whether there is a charging facility at the destination, and the charging facility information of the destination can alternatively be acquired by searching a map, that is, acquired from distribution information of charging stations indicated on the map.

Particularly different predetermined routes can be determined according to whether there is a charging facility at the destination, and when there is a charging facility at the destination, the predetermined route runs from the origin to the destination; and when there is no charging facility at the destination, the predetermined route runs from the origin to the destination and further from the destination to a charging station nearby the destination, and preferably the charging station nearby the destination is a charging station at which the electric vehicle can arrive starting from the destination with the least amount of power E.

Whether charging is required on the way of traveling over the predetermined routes is determined according to a voyage mileage of the initial amount of power of the electric vehicle, and if the initial amount of power is sufficient to have the electric vehicle travel to the destination (with a charging facility) or the charging station nearby the destination, then it travels directly over the predetermined route; otherwise, a charging station is selected for charging on the way, and the selected charging station can have the entire traveling route optimal.

In this embodiment, firstly a plurality of candidate routes are determined, and each candidate route corresponds to a sequence of candidate charging stations, where the sequence of candidate charging stations is constituted of one or more candidate charging stations.

Particularly the sequence of candidate charging stations can be determined from a search in numerous ways, for example, the sequence of candidate charging stations can be determined by searching starting from the origin to the destination, or the sequence of candidate charging stations can be determined by searching concurrently starting from both the origin and the destination and terminating the search when there is an intersection of search ranges corresponding to the two points and determining the sequence of candidate charging stations in the intersection of the search ranges. A practical application will not be limited to the search-determination ways listed above, and other ways in which sequences of candidate charging stations corresponding to the respective routes can be determined shall also be encompassed in the embodiment of the invention.

A process of determining candidate charging stations by searching starting from the origin to the destination will be detailed below.

Preferably when the charging facility information of the destination indicates that there is a charging facility, a specific process of determining location information of respective candidate charging stations and respective sequences of candidate charging stations is as follows:

A. With the initial amount of power being a remaining amount of power and the location of the origin being a search start point, an initial search range is determined according to the maximum mileage over which traveling can proceed with the remaining amount of power and to the search start point;

B. If the initial search range does not cover the destination, then respective candidate charging stations included in the initial search range are determined, and when the number of the respective candidate charging stations included in the initial search range is below a preset threshold, the initial search range is adjusted according to the remaining amount of power and the search start point until the number of candidate charging stations reaches the preset threshold; or if the initial search range covers the destination, then respective search start points other than the origin through which the route runs sequentially from the origin to the destination are taken as a sequence of candidate charging stations; and

C. With the determined respective candidate charging stations being search start points and the amounts of power after charging being remaining amounts of power, initial search ranges of the respective search start points are determined again, and the step B is repeated.

Preferably when the charging facility information of the destination indicates that there is no charging facility, a search is made for a charging station that can be reached starting from the location of the destination with the least amount of power E, and after the charging station and the least amount of power E are determined, a specific process of determining location information of respective candidate charging stations and respective sequences of candidate charging stations is as follows:

A. With the initial amount of power being a remaining amount of power and the origin being a search start point, an initial search range is determined according to the maximum mileage over which traveling can proceed with the remaining amount of power and to the search start point;

B. If the initial search range does not cover the destination or has a remaining amount of power below E upon arrival at the destination from the search start point, then respective candidate charging stations included in the initial search range are determined, and when the number of the respective candidate charging stations included in the initial search range is below a preset threshold, the initial search range is adjusted according to the remaining amount of power and the search start point until the number of candidate charging stations reaches the preset threshold; or if the initial search range covers the destination and has a remaining amount of power not below E upon arrival at the destination from the search start point, then respective search start points other than the origin through which the route runs sequentially from the origin to the destination are taken as a sequence of candidate charging stations; and

C. With the determined respective candidate charging stations being search start points and amounts of power after charging being remaining amounts of power, initial search ranges of the respective search start points are determined again, and the step B is repeated.

Specifically the initial search range can be determined according to the maximum mileage over which traveling can proceed with the remaining amount of power (i.e., a voyage mileage) and to the search start point (the origin or a candidate charging station) by determining the initial search range with a predetermined proportion of the voyage mileage of the remaining amount of power being the largest search span to thereby ensure that the electric vehicle can travel to the respective candidate charging stations in the initial search range or the location of the destination.

Preferably in the foregoing two processes of determining a sequence of candidate charging stations, the initial search range is determined particularly by taking as an initial search range an area toward the destination within an angle which is a given initial angle with the line connecting the origin and the destination being a line bisecting the angle; and

When the number of candidate charging stations included in the initial search range is below the preset threshold, the initial search range is adjusted particularly by increasing gradually the degrees of the angle of the area which is the initial search range until the number of included candidate charging stations reaches the preset threshold.

For example, the initial search range is determined by determining as an initial search range a sector area with the search start point as a vertex, with the maximum mileage over which traveling can proceed with the remaining amount of power as a radius, with the central axis pointing to the destination, and with an initial angle of 60 degrees; and the angle of the sector area which is the initial search range is increased gradually until the number of included candidate charging stations reaches the preset threshold.

In a practical application, the initial search range can alternatively be determined as the largest range, for example, a circle area with the origin being the center of a circle. In a practical application, the initial search range can alternatively be determined as an area in another shape, and the embodiment of the invention will not be limited thereto.

For example, the sector search area can be determined with 70% of the voyage mileage of the remaining amount of power as a search radius and the location of the origin being the vertex.

In a particular implementation, when the sector area toward the destination is determined as an initial search range, if the number of candidate charging stations included in the range is found below the preset threshold, then the search range is widen to search in a range away from the destination to thereby ensure the locations of candidate charging stations be located as many as possible on the way from the location of the origin to the location of the destination, thus lowering a cost as much as possible of a detour for charging, for example, the amount of consumed time, the amount of consumed power or the length of a traveling route.

For example, a section area is determined with the search start point being the vertex and the central axis of the sector area pointing the location of the destination, and candidate charging stations are searched for according to map information corresponding to the sector area; and if there is no candidate charging station in the sector area or the number of candidate charging stations therein is below a preset threshold of 5, then the search range is widen by determining a circle area with the location of the origin being the central of a circle, and candidate charging stations are searched for according to map information corresponding to the circle area.

For example, when there is a charging facility at the destination, a first search range is determined according to the origin and the voyage mileage of the initial amount of power, and if the destination is not in the first search range, then candidate charging stations CS1 and CS2 included in the first search range are determined; a second search range and a third search range are determined with CS1 and CS2 respectively being search start points and the amounts of power after charging being remaining amounts of power, it is determined whether the determined second search range and third search range cover the destination, and if not so, then candidate charging stations CS3 and CS4 included in the second search range are determined, and sequences of candidate charging stations 1 and 2 are determined as the sequence 1 including CS1 and CS3 and the sequence 2 including CS1 and CS4, and alike candidate charging stations CS5 and CS6 included in the third search range are determined, and sequences of candidate charging stations 3 and 4 are determined as the sequence 3 including CS2 and CS5 and the sequence 4 including CS2 and CS6; and a fourth search range to a seventh search range are determined with CS3, CS4, CS5 and CS6 respectively being search start points and the amounts of power after charging being remaining amounts of power, and the search process is terminated upon determining that at least one of these four search ranges covers the location of the destination.

Preferably when there is a charging facility at the destination, after the respective search ranges are determined with the currently determined candidate charging stations respectively being search start points and the amounts of power after charging being remaining amounts of power, if at least one search range covers the destination, then only the sequence of candidate charging stations corresponding to the search range covering the destination is preserved.

Alternatively when there is no charging facility at the destination, if at least one search range covers the destination and has the remaining amount of power not below E upon arrival at the destination from the search start point, then only the sequence of candidate charging stations corresponding to the search range covering the destination and with the remaining amount of power being not below E upon arrival at the destination from the search start point is preserved.

For example, also in the search process illustrated above, if it is determined that both the fifth search range and the sixth search range corresponding to CS4 and CS5 cover the destination and that neither the fourth search range nor the seventh search range corresponding to CS3 and CS6 covers the destination, then the sequences corresponding to the candidate charging stations CS4 and CS5 which are the search start points of the fifth search range and the sixth search range are preserved, that is, the sequence 2 and the sequence 3 are determined respectively as final sequences of candidate charging stations.

In a particular implementation, for more selections available, in the case that there is a charging facility at the destination, the search process can be terminated when the number of search ranges covering the destination exceeds a preset threshold; and in the case that there is no charging facility at the destination, the search process can be terminated when the number of search ranges covering the destination and with the remaining amount of power being not below E upon arrival at the destination from the search start point exceeds a preset threshold.

The step 202 is to calculate for each sequence of candidate charging stations a route parameter of arrival at the destination from the origin sequentially through the candidate charging stations included in the sequence of candidate charging stations.

In an embodiment of the invention, the route parameter includes but is not limited to the length of consumed time, the amount of consumed power and the length of route.

The step 203 is to select an optimal route according to the route parameters of the respective sequences of candidate charging stations and a predetermined route selection criterion.

Preferably in an embodiment of the invention, the optimal route can be selected according to the respective route parameters by selecting the route with the least length of consumed time as an optimal route or selecting the route with the least amount of consumed power as an optimal route or selecting the route with the least length of route as an optimal route.

Specifically the route with the least length of consumed time is the fastest route, that is, the route with the least total length of consumed time among all the routes is the fastest route, where the total length of consumed time includes the length of consumed time from the origin to the first candidate charging station in the sequence of candidate charging stations, the lengths of consumed time traveling from the first candidate charging station in the sequence of candidate charging stations to the last candidate charging station in the sequence of candidate charging stations, the length of consumed time at each candidate charging station (e.g., a duration of charging and a duration of being queued and waiting) and the length of consumed time from the last candidate charging station in the sequence of candidate charging stations to the destination. Taking charging once on the way as an example, the total length of consumed time is calculated as T1+T2+T3, where T1 represents the length of time from the origin to the candidate charging station, T2 represents the length of time consumed at the charging station (including a duration of being queued and waiting and a duration of charging), and T3 represents the length of time from the charging station to the destination.

Specifically the route with the least amount of consumed power is the most power-saving route, that is, the route with the least total amount of consumed power among all the routes, and the total amount of consumed power includes the amount of power consumed from the origin to the first candidate charging station in the sequence of candidate charging stations, the amounts of power consumed from the first candidate charging station in the sequence of candidate charging stations to the last candidate charging station in the sequence of candidate charging stations and the amount of power consumed from the last candidate charging station in the sequence of candidate charging stations to the destination. Taking charging once on the way as an example, the total amount of consumed power is calculated as E1+E2, where E1 represents the amount of consumed power from the origin to the charging station, and E2 represents the amount of consumed power from the charging station to the destination.

Specifically the route with the least length of route is the shortest route, that is, the route with the least total length of route among all the routes, and the total length of route includes the distance from the origin to the first candidate charging station in the sequence of candidate charging stations, the distances from the first candidate charging station in the sequence of candidate charging stations sequentially to the last candidate charging station in the sequence of candidate charging stations and the distance from the last candidate charging station in the sequence of candidate charging stations to the destination. Taking charging once on the way as an example, the total length of route is calculated as D1+D2, where D1 represents the distance from the origin to the charging station, and D2 represents the distance from the charging station to the destination.

The route planning method according to the embodiments of the invention will be further described below by way of examples.

In a first example, as illustrated in FIG. 3, an origin O and a destination D specified by a user are received, the absence of a charging facility at the destination D is determined from map information, and the amount of power consumed upon arrival at a charging station CS7 from the destination D is determined as the least; with a predetermined route from the O point to the D point further to CS7, it is determined from an initial amount of power of the electric vehicle that the electric vehicle can travel from O to D to CS7 only if it is charged at least once on the way; a sector area OAB is determined with the location of O being the vertex, 70% of a voyage mileage of the initial amount of power being the radius and an initial angle being 60 degrees, and candidate charging stations CS1, CS2 and CS3 are found by searching in the sector area; sector areas 1, 2 and 3 are determined with CS1, CS2 and CS3 respectively being vertexes and 70% of the voyage mileages of amounts of power after charging being radiuses, and it is determined that all the sector areas 1, 2 and 3 cover D and have a remaining amount of power upon arrival at D sufficient to arrive at CS7, and then CS1, CS2 and CS3 are determined respectively as three sequences of candidate charging stations; and the total length of consumed time of a route R1, R2 or R3 over which the destination is reached through the candidate charging station CS1, CS2 or CS3 is calculated respectively as Ti1+Ti2+Ti3 (i=1, 2, 3), and assumed T11+T12+T13=18 minutes, T21+T22+T23=15 minutes, and T31+T32+T33 =20 minutes, the user is provided with R2 as the fastest route because the value of T21+T22+T23 is the smallest.

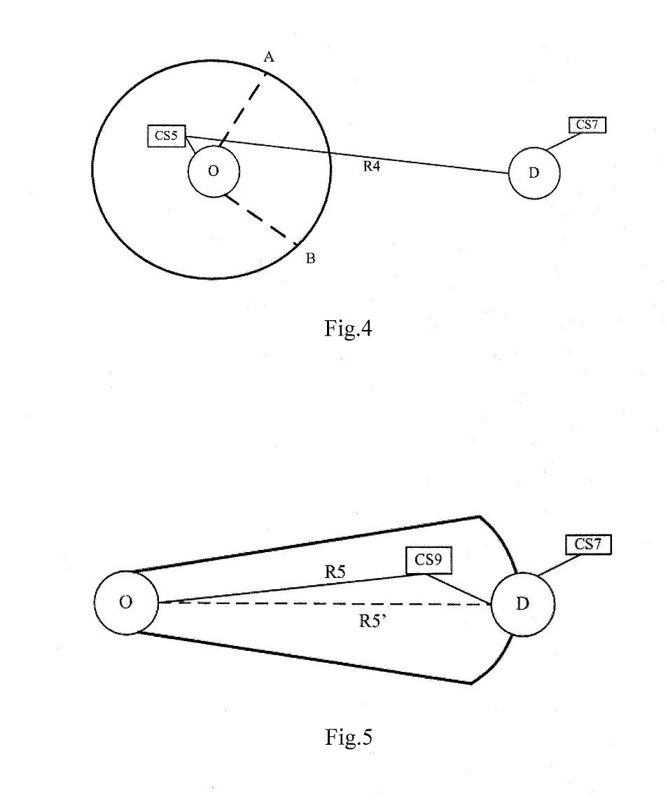

In a second example, as illustrated in FIG. 4, when there is no candidate charging station in the sector area OAB at an initial angle of 60 degrees illustrated in the first example, the angle of the sector OAB is increased gradually to search in a larger range for candidate charging stations until it is extended to a circle area, and if there is a charging station CS5 in the circle area, then in this case CS5 will be taken as a candidate charging station although CS5 is located in the direction away from the location of D, and a final path planning result is a route R4, that is, from the location of O to CS5 for charging and further to the location of D.

In a third example, as illustrated in FIG. 5, assumed when the electric vehicle travels over the route R5′, the initial amount of power at the origin O is just sufficient to arrive at the destination D but not sufficient to arrive at a charging station CS7 nearby D, and at this time a candidate charging station CS9 can be searched for in a sector area with the origin O being the vertex, the line connecting the origin O and the destination D being the central axis and the line connecting the origin O and the destination D being the radius, and a path planning result is a route R5, that is, from the location of O to CS9 and further to the location of D.

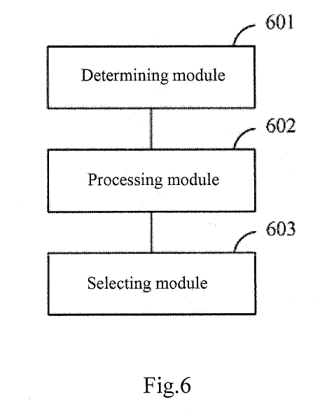

Based upon the same principle, an embodiment of the invention further provides an apparatus, which may be stored a computer readable storage medium, for planning a route of an electric vehicle, which is implemented under a similar principle to that of the foregoing method of planning a route of an electric vehicle, and for details thereof, reference can be made to the foregoing description of the method, so a repeated description thereof will be omitted here. As illustrated in FIG. 6, the apparatus for planning a route of an electric vehicle generally includes the following modules:

A determining module 601 configured to determine location information of respective candidate charging stations and respective sequences of candidate charging stations according to acquired location information of an origin and location information of a destination as predetermined, charging facility information of the destination and an initial amount of power;

A processing module 602 configured to calculate for each sequence of candidate charging stations a route parameter of arrival at the destination from the origin sequentially through the candidate charging stations included in the sequence of candidate charging stations; and

A selecting module 603 configured to select an optimal route according to route parameters of the respective sequences of candidate charging stations and a predetermined route selection criterion.

Particularly when the charging facility information of the destination indicates that there is a charging facility, the determining module 601 is further configured to perform the steps of: A. with the initial amount of power being a remaining amount of power and the location of the origin being a search start point, determining an initial search range according to the maximum mileage over which traveling can proceed with the remaining amount of power and to the search start point;

B. if the initial search range does not cover the destination, then determining respective candidate charging stations included in the initial search range, and when the number of the respective candidate charging stations included in the initial search range is below a preset threshold, adjusting the initial search range according to the remaining amount of power and the search start point until the number of candidate charging stations reaches the preset threshold; or if the initial search range covers the destination, then taking as a sequence of candidate charging stations respective search start points other than the origin through which a route runs sequentially from the origin to the destination; and

C. with the determined respective candidate charging stations being search start points and the amounts of power after charging being remaining amounts of power, determining initial search ranges of the respective search start points again, and repeating the step B.

Particularly when the charging facility information of the destination indicates that there is no charging facility, the determining module 601 is further configured to search for a charging station that can be reached starting from the location of the destination with the least amount of power E; and

The determining module is further configured to perform the steps of: A. with the initial amount of power being a remaining amount of power and the origin being a search start point, determining an initial search range according to the maximum mileage over which traveling can proceed with the remaining amount of power and to the search start point;

B. if the initial search range does not cover the destination or has the remaining amount of power below E upon arrival at the destination from the search start point, then determining respective candidate charging stations included in the initial search range, and when the number of the respective candidate charging stations included in the initial search range is below a preset threshold, adjusting the initial search range according to the remaining amount of power and the search start point until the number of candidate charging stations reaches the preset threshold; or if the initial search range covers the destination and has the remaining amount of power not below E upon arrival at the destination from the search start point, then taking as a sequence of candidate charging stations respective search start points other than the origin through which the route runs sequentially from the origin to the destination; and

C. with the determined respective candidate charging stations being search start points and the amounts of power after charging being remaining amounts of power, determining initial search ranges of the respective search start points again, and repeating the step B.

Preferably the determining module 601 is further configured to determine the initial search range by taking as an initial search range an area toward the destination within an angle which is a given initial angle with the line connecting the origin and the destination being a line bisecting the angle; and to adjust the initial search range by increasing gradually the degrees of the angle of the area which is the initial search range until the number of included candidate charging stations reaches the preset threshold.

In an embodiment of the invention, the route parameter includes but is not limited to the length of consumed time, the amount of consumed power and the length of route.

Particularly the selecting module 603 is further configured to select the optimal route by selecting the route with the least length of consumed time as an optimal route or selecting the route with the least amount of consumed power as an optimal route or selecting the route with the least length of route as an optimal route.

Based upon the foregoing technical solutions, in the embodiments of the invention, after location information of an origin and location information of a destination as predetermined and charging facility information of the destination is acquired, location information of respective candidate charging stations on the way and respective sequences of candidate charging stations are determined in combination with an initial amount of power, and with a route determined for each sequence of candidate charging stations, a route parameter of arrival at the destination from the origin through the respective candidate charging stations included in the sequence of candidate charging stations is calculated, and the route parameters are compared and then an optimal route is selected therefrom as a globally optimal traveling route. The optimal route is selected also taking into account a charging facility condition of the destination, and a next trip of the electric vehicle upon arrival at the destination is guaranteed so that the electric vehicle can arrive at the destination smoothly and prepare for the next trip.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method of planning a route of an electric vehicle, comprising:
determining location information of respective candidate charging stations and respective sequences of candidate charging stations according to acquired location information of an origin and location information of a destination as predetermined, charging facility information of the destination and an initial amount of power;
calculating for each sequence of candidate charging stations a route parameter of arrival at the destination from the origin sequentially through candidate charging stations comprised in the sequence of candidate charging stations; and
selecting an optimal route according to route parameters of the respective sequences of candidate charging stations and a predetermined route selection criterion.

2. The method according to claim 1, wherein when the charging facility information of the destination indicates that there is a charging facility, the determining the location information of the respective candidate charging stations and the respective sequences of candidate charging stations comprises:
A. with the initial amount of power being a remaining amount of power and a location of the origin being a search start point, determining an initial search range according to a maximum mileage over which traveling can proceed with the remaining amount of power and to the search start point;
B. when the initial search range does not cover the destination, determining respective candidate charging stations comprised in the initial search range, and when the number of the respective candidate charging stations comprised in the initial search range is below a preset threshold, adjusting the initial search range according to the remaining amount of power and the search start point until the number of candidate charging stations reaches the preset threshold; or when the initial search range covers the destination, taking as a sequence of candidate charging stations respective search start points other than the origin sequentially on a way from the origin to the destination; and
C. with determined respective candidate charging stations being search start points and amounts of power after charging being remaining amounts of power, determining initial search ranges of the respective search start points again, and repeating the step B.

3. The method according to claim 2, wherein the route parameter comprises a length of consumed time, an amount of consumed power and a length of route; and
selecting the optimal route comprises:
selecting a route with a least length of consumed time as the optimal route; or selecting a route with a least amount of consumed power as the optimal route; or selecting a route with a least length of route as the optimal route.

4. The method according to claim 3, wherein the length of consumed time is a sum of a length of time for arrival at the destination from the origin through respective candidate charging stations comprised in a sequence of candidate charging stations and durations of waiting and durations of charging at the respective candidate charging stations.

5. The method according to claim 2, wherein the determining the initial search range comprises:
taking as the initial search range an area toward the destination within an angle which is a given initial angle with a line connecting the origin and the destination being a line bisecting the angle; and
the adjusting the initial search range comprises:
increasing gradually degrees of the angle of the area which is the initial search range until the number of comprised candidate charging stations reaches the preset threshold.

6. The method according to claim 1, wherein when the charging facility information of the destination indicates that there is no charging facility, the method further comprises searching for a charging station that can be reached starting from a location of the destination with a least amount of power E; and
determining the location information of the respective candidate charging stations and the respective sequences of candidate charging stations comprises:
A. with the initial amount of power being a remaining amount of power and the origin being a search start point, determining an initial search range according to a maximum mileage over which traveling can proceed with the remaining amount of power and to the search start point;
B. when the initial search range does not cover the destination or has a remaining amount of power below E upon arrival at the destination from the search start point, determining respective candidate charging stations comprised in the initial search range, and when the number of the respective candidate charging stations comprised in the initial search range is below a preset threshold, adjusting the initial search range according to the remaining amount of power and the search start point until the number of candidate charging stations reaches the preset threshold; or when the initial search range covers the destination and has the remaining amount of power not below E upon arrival at the destination from the search start point, taking as a sequence of candidate charging stations respective search start points other than the origin sequentially on a way from the origin to the destination; and
C. with determined respective candidate charging stations being search start points and amounts of power after charging being remaining amounts of power, determining initial search ranges of the respective search start points again, and repeating the step B.

7. The method according to claim 6, wherein the route parameter comprises a length of consumed time, an amount of consumed power and a length of route; and
selecting the optimal route comprises:
selecting a route with a least length of consumed time as the optimal route; or
selecting a route with a least amount of consumed power as the optimal route; or
selecting a route with a least length of route as the optimal route.

8. The method according to claim 7, wherein the length of consumed time is a sum of a length of time for arrival at the destination from the origin through respective candidate charging stations comprised in a sequence of candidate charging stations and durations of waiting and durations of charging at the respective candidate charging stations.

9. The method according to claim 6, wherein the determining the initial search range comprises:
taking as the initial search range an area toward the destination within an angle which is a given initial angle with a line connecting the origin and the destination being a line bisecting the angle; and
the adjusting the initial search range comprises:
increasing gradually degrees of the angle of the area which is the initial search range until the number of comprised candidate charging stations reaches the preset threshold.

10. The method according to claim 1, wherein the route parameter comprises a length of consumed time, an amount of consumed power and a length of route; and
selecting the optimal route comprises:
selecting a route with a least length of consumed time as the optimal route; or
selecting a route with a least amount of consumed power as the optimal route; or
selecting a route with a least length of route as the optimal route.

11. The method according to claim 10, wherein the length of consumed time is a sum of a length of time for arrival at the destination from the origin through respective candidate charging stations comprised in a sequence of candidate charging stations and durations of waiting and durations of charging at the respective candidate charging stations.

12. An apparatus for planning a route of an electric vehicle, comprising:
a determining module configured in a computer readable storage medium to determine location information of respective candidate charging stations and respective sequences of candidate charging stations according to acquired location information of an origin and location information of a destination as predetermined, charging facility information of the destination and an initial amount of power;
a processing module configured to calculate for each sequence of candidate charging stations a route parameter of arrival at the destination from the origin sequentially through candidate charging stations comprised in the sequence of candidate charging stations; and
a selecting module configured to select an optimal route according to route parameters of the respective sequences of candidate charging stations and a predetermined route selection criterion.

13. The apparatus according to claim 12, wherein when the charging facility information of the destination indicates that there is a charging facility, the determining module is further configured to perform the steps of:
A. with the initial amount of power being a remaining amount of power and a location of the origin being a search start point, determining an initial search range according to a maximum mileage over which traveling can proceed with the remaining amount of power and to the search start point;
B. when the initial search range does not cover the destination, determining respective candidate charging stations comprised in the initial search range, and when the number of the respective candidate charging stations comprised in the initial search range is below a preset threshold, adjusting the initial search range according to the remaining amount of power and the search start point until the number of candidate charging stations reaches the preset threshold; or when the initial search range covers the destination, taking as a sequence of candidate charging stations respective search start points other than the origin sequentially on a way from the origin to the destination; and
C. with determined respective candidate charging stations being search start points and amounts of power after charging being remaining amounts of power, determining initial search ranges of the respective search start points again, and repeating the step B.

14. The apparatus according to claim 13, wherein the selecting module is further configured to select the optimal route by selecting a route with a least length of consumed time as the optimal route; or selecting a route with a least amount of consumed power as the optimal route; or selecting a route with a least length of route as the optimal route.

15. The apparatus according to claim 13, wherein the determining module is further configured to determine the initial search range by taking as the initial search range an area toward the destination within an angle which is a given initial angle with a line connecting the origin and the destination being a line bisecting the angle; and
to adjust the initial search range by increasing gradually degrees of the angle of the area which is the initial search range until the number of comprised candidate charging stations reaches the preset threshold.

16. The apparatus according to claim 12, wherein when the charging facility information of the destination indicates that there is no charging facility, the determining module is further configured to search for a charging station that can be reached starting from a location of the destination with a least amount of power E; and
to perform the steps of:
A. with the initial amount of power being a remaining amount of power and the origin being a search start point, determining an initial search range according to a maximum mileage over which traveling can proceed with the remaining amount of power and to the search start point;
B. when the initial search range does not cover the destination or has a remaining amount of power below E upon arrival at the destination from the search start point, determining respective candidate charging stations comprised in the initial search range, and when the number of the respective candidate charging stations comprised in the initial search range is below a preset threshold, adjusting the initial search range according to the remaining amount of power and the search start point until the number of candidate charging stations reaches the preset threshold; or when the initial search range covers the destination and has the remaining amount of power not below E upon arrival at the destination from the search start point, taking as a sequence of candidate charging stations respective search start points other than the origin sequentially on a way from the origin to the destination; and
C. with determined respective candidate charging stations being search start points and amounts of power after charging being remaining amounts of power, determining initial search ranges of the respective search start points again, and repeating the step B.

17. The apparatus according to claim 16, wherein the selecting module is further configured to select the optimal route by selecting a route with a least length of consumed time as the optimal route; or selecting a route with a least amount of consumed power as the optimal route; or selecting a route with a least length of route as the optimal route.

18. The apparatus according to claim 16, wherein the determining module is further configured to determine the initial search range by taking as the initial search range an area toward the destination within an angle which is a given initial angle with a line connecting the origin and the destination being a line bisecting the angle; and
to adjust the initial search range by increasing gradually degrees of the angle of the area which is the initial search range until the number of comprised candidate charging stations reaches the preset threshold.

19. The apparatus according to claim 12, wherein the selecting module is further configured to select the optimal route by selecting a route with a least length of consumed time as the optimal route; or selecting a route with a least amount of consumed power as the optimal route; or selecting a route with a least length of route as the optimal route.
